(19) United States
(12) Patent Application Publication
(10) Pub. No.: US 2017/0368806 A1
(43) Pub. Date: Dec. 28, 2017

(54) ACTIVE ENERGY RAY-CURABLE RESIN COMPOSITION, COATING MATERIAL, COATING FILM, AND FILM

(71) Applicant: DIC Corporation, Tokyo (JP)

(72) Inventors: Dongmi SHIN, Chiba (JP); Takuji TSUKAMOTO, Chiba (JP); Masahiro ITO, Chiba (JP)

(73) Assignee: DIC Corporation, Tokyo (JP)

(21) Appl. No.: 15/537,876

(22) PCT Filed: Nov. 12, 2015
(86) PCT No.: PCT/JP2015/081843

§ 371 Date: Jun. 19, 2017

(30) Foreign Application Priority Data
Dec. 24, 2014 (JP) 2014-260358

(51) Int. Cl. B32B 27/20; C09D 7/12; C08F 292/00; C08F 290/00; C08F 2/44; C09D 133/04; B32B 27/30

(52) U.S. Cl. CPC B32B 27/20; C09D 133/04; C09D 7/12; B32B 27/30; C08F 290/00; C08F 2/44; C08F 292/00

(57) ABSTRACT

There are provided an active-energy-ray-curable resin composition of which a cured coating film has a high surface hardness, high transparency, high resistance to curling, and high surface smoothness; a coating material containing such a resin composition; a coating film formed of the coating material; and a film containing a layer of the coating film. In particular, an active-energy-ray-curable resin composition containing fine wet-process silica particles (A) subjected to a hydrophobic treatment and a compound (B) having a (meth)acryloyl group is provided. Also provided are a coating material containing such a resin composition, a coating film formed by curing the coating material, and a laminated film having a layer of the coating film.

### TECHNICAL FIELD

The present invention relates to an active-energy-ray-curable resin composition which enables formation of a cured coating film having a good surface smoothness without use of a leveling agent and of which the cured coating film has a high surface hardness, high transparency, and high resistance to curling. The present invention also relates to a coating material containing such a resin composition, a coating film formed of the coating material, and a film including a layer of the coating film.

### BACKGROUND ART

In recent years, inorganic-fine-particles-dispersed active-energy-ray-curable resin compositions that can be obtained by dispersing inorganic fine particles in a resin component have been expected as a new material that can give cured coating films high performance and new functions, such as enhanced hardness, a controlled refractive index, and conductivity, as compared with resin compositions containing merely organic materials. Such resin compositions can be used in a variety of applications; for example, in the case where they are used as a hard coating agent for protecting the surfaces of shaped products and displays from being damaged because cured coating films of the resin composition have a high hardness, use of this hard coating agent can give much greater scratch resistance than use of resin compositions containing only organic materials. In particular, it is effective to increase the amount of the inorganic fine particles in order to produce a hard coating agent that enables formation of a coating film with further enhanced hardness; however, in a resin composition containing an increased amount of inorganic fine particles, the inorganic fine particles are readily deposited with time, which causes a problem of reduced storage stability. In the case where the inorganic fine particles are not sufficiently dispersed in the resin component, the resin composition causes problems of the reduced transparency of a coating film and the curling of a film on curing as well as the problem of reduced storage stability.

A known hard coating agent of an inorganic-fine-particles-dispersed active-energy-ray-curable resin composition is a resin composition used in an anti-glare film; and this resin composition contains a polymer produced by addition of an acrylic acid to an acrylic polymer of glycidyl methacrylate, trimethylolpropane triacrylate, polyfunctional urethane acrylate, and fine silica particles having an average particle size ranging from 297 to 540 nm (for example, see Patent Literature 1). Such a dispersion enables formation of a coating film with enhanced hardness as compared with a hard coating agent containing only organic materials; however, the fine silica content in the nonvolatile component of the resin composition is just approximately 17%, and thus the dispersion cannot satisfy the recent market demand for further enhanced surface hardness. Furthermore, since this resin composition is used in anti-glare films, the fine silica particles used have a very large particle size; hence, the resin composition is impractical for forming a cured coating film having a high transparency. Another known one is a reactive dispersion containing an acrylic polymer having an acryloyl equivalent of 214 g/eq, a hydroxyl value of 262 mgKOH/g, and a weight average molecular weight of 40,000 and fine alumina or zirconia particles having an average particle size ranging from 55 to 90 nm (for instance, see Patent Literature 2). Such a dispersion enables formation of a coating film with enhanced hardness as compared with a hard coating agent containing only organic materials; however, the inorganic fine particles in the dispersion have a small average particle size, and thus the dispersion cannot give coating films enough hardness to reach the required standard that has been increasingly enhanced these days.

Another technique has been suggested, in which an active-energy-ray-curable resin composition containing colloidal silica as fine silica particles and an acrylic polymer having (meth)acryloyl groups as side chains is used to form a cured coating film with enhanced hardness and resistance to curling (for instance, see Patent Literature 3). Furthermore, use of fumed silica as the fine silica particles has been suggested (for example, see Patent Literature 4). Coating films formed of the composition containing colloidal silica, however, have an insufficient surface hardness. In the use of fumed silica, the fumed silica is likely to agglomerate in curing, and insufficient surface smoothness and curling are caused in many cases. Thus, a material that can give both high surface smoothness and high resistance to curling in a well-balanced manner has been demanded.

### CITATION LIST

### Patent Literature

PTL 1: Japanese Unexamined Patent Application Publication No. 2008-62539

PTL 2: Japanese Unexamined Patent Application Publication No. 2007-289943

PTL 3: Japanese Unexamined Patent Application Publication No. 2010-100817

PTL 4: Japanese Unexamined Patent Application Publication No. 2013-108009

### SUMMARY OF INVENTION

### Technical Problem

It is an object of the present invention to provide an active-energy-ray-curable resin composition of which a cured coating film has a high surface hardness, high transparency, high resistance to curling, and high surface smoothness. It is another object of the present invention to provide a coating material containing such a resin composition, a coating film formed of the coating material, and a film including a layer of the coating film.

### Solution to Problem

The inventors have intensively studied to achieve the above-mentioned objects and found that using an active-energy-ray-curable resin composition containing fine wet-process silica particles (A) subjected to a hydrophobic treatment and a compound (B) having a (meth)acryloyl group enables the objects to be achieved, thereby accomplishing the present invention.

In particular, the present invention provides an active-energy-ray-curable resin composition containing fine wet-process silica particles (A) subjected to a hydrophobic treatment, fine wet-process silica particles (A) subjected to a hydrophobic treatment, and a compound (B) having a (meth)acryloyl group. The present invention also provides a coating material containing such a composition, a coating film formed by curing the composition, and a laminated film including the cured coating film.

### Advantageous Effects of Invention

According to the present invention, there can be provided an active-energy-ray-curable resin composition of which a cured coating film has a high surface hardness, high transparency, high surface smoothness, and high resistance to curling; a coating material containing such a resin composition; a coating film formed of the coating material; and a film including a layer of the coating film.

### DESCRIPTION OF EMBODIMENTS

The active-energy-ray-curable resin composition of the present invention contains a fine wet-process silica particles (A) subjected to a hydrophobic treatment and a compound (B) having a (meth)acryloyl group as essential components.

In the active-energy-ray-curable resin composition of the present invention, use of the fine wet-process silica particles (A) subjected to a hydrophobic treatment enables formation of a cured coating film having an enhanced surface hardness; in addition, the fine particles (A) are well dispersible in the composition, which contributes to a reduction in the uneven shrinkage of a film on curing thereof. Thus, a cured coating film having an excellent surface smoothness and resistance to curling can be formed. The average particle size of the fine particles (A), which is measured in a state in which the particles have been dispersed in the composition, is preferably in the range of 80 to 150 nm, and more preferably 90 to 130 nm in terms of the good balance between the surface hardness and transparency of a coating film to be formed.

The average particle size of the fine silica particles (A) in the present invention is determined by measuring the particle size thereof in the active-energy-ray-curable resin composition with a particle size analyzer (“ELSZ-2” manufactured by Otsuka Electronics Co., Ltd.).

The fine silica particles (A) used in the active-energy-ray-curable resin composition of the present invention are produced by a hydrophobic treatment of a fine wet-process silica particles used as a raw material. The surfaces of fine silica particles obtained by a wet process, such as neutralization of sodium silicate with a mineral acid, have a lot of hydrophilic silanol groups; in this state, the fine silica particles are less compatible with the active-energy-ray-curable resin or an active-energy-ray-curable compound and are hard to be uniformly dispersed. Hence, the surfaces of the fine silica particles need to be made to be hydrophobic by the reaction of the silanol groups on the surfaces with a hydrophobic compound or the adsorption of such a compound to the surfaces.

A variety of hydrophobic treatments can be used; for example, a treatment with silanes or silicones can be employed. In particular, polydimethylsiloxane is preferably used for the treatment because it has a high effect, well compatible with other components used in the active-energy-ray-curable resin composition, and does not impair the transparency of a cured coating film to be formed. It is known that fine silica particles obtained by a wet process generally have a large particle size, and the hydrophobic treatment is therefore preferably performed in the middle of a wet process for producing the fine silica particles.

The fine wet-process silica particles (A) subjected to a hydrophobic treatment in the present invention is in an agglomerated state in many cases, and the average particle size thereof, which is measured with a coulter counter, is likely to be in the range of 0.5 to 10 μm. As described above, using the particles being in such a state of agglomerates having a large particle size in the active-energy-ray-curable resin composition may impair the storage stability of the composition and also affect the surface smoothness and transparency of a cured coating film to be formed; hence, the particles are preferably finely dispersed by, for example, a technique described later when they are used in the composition.

The active-energy-ray-curable resin composition of the present invention contains the other essential component that is the compound (B) having a (meth)acryloyl group as a reactive compound for fixing the fine wet-process silica particles (A) subjected to a hydrophobic treatment in a coating film.

The compound (B) having a (meth)acryloyl group is not particularly limited; examples thereof include (meth)acrylate monomers, urethane (meth)acrylate, and oligomer-type resins having a (meth)acryloyl group. A (meth)acrylate monomer having two or more (meth)acryloyl groups per molecule and an acrylic polymer (X) having a (meth)acryloyl group in its molecular structure are preferred because use thereof easily enables a further enhancement in the hardness of the intended coating film.

Examples of the (meth)acrylate monomers include mono(meth)acrylates such as 2-hydroxyethyl (meth)acrylate, 2-hydroxypropyl (meth) acrylate, 2-hydroxybutyl (meth)acrylate, n-butyl (meth)acrylate, isobutyl (meth)acrylate, t-butyl (meth)acrylate, glycidyl (meth) acrylate, acryloylmorpholine, N-vinylpyrrolidone, tetrahydrofurfuryl acrylate, cyclohexyl (meth)acrylate, 2-ethylhexyl (meth) acrylate, isobornyl (meth) acrylate, isodecyl (meth)acrylate, lauryl (meth)acrylate, tridecyl (meth)acrylate, cetyl (meth)acrylate, stearyl (meth)acrylate, benzyl (meth)acrylate, 2-ethoxyethyl (meth)acrylate, 3-methoxybutyl (meth) acrylate, ethylcarbitol (meth) acrylate, phosphoric acid (meth) acrylate, ethylene-oxide-modified phosphoric acid (meth)acrylate, phenoxy (meth)acrylate, ethylene-oxide-modified phenoxy (meth)acrylate, propylene-oxide-modified phenoxy (meth) acrylate, nonylphenol (meth) acrylate, ethylene-oxide-modified nonylphenol (meth) acrylate, propylene-oxide-modified nonylphenol (meth) acrylate, methoxydiethylene glycol (meth) acrylate, methoxypolyethylene glycol (meth) acrylate, methoxypropylene glycol (meth) acrylate, 2-(meth)acryloyloxyethyl-2-hydroxypropyl phthalate, 2-hydroxy-3-phenoxypropyl (meth)acrylate, 2-(meth)acryloyloxyethyl hydrogen phthalate, 2-(meth)acryloyloxypropyl hydrogen phthalate, 2-(meth)acryloyloxypropyl hydrogen hexahydrophthalate, 2-(meth)acryloyloxypropyl hydrogen tetrahydrophthalate, dimethylaminoethyl (meth) acrylate, trifluoroethyl (meth) acrylate, tetrafluoropropyl (meth) acrylate, hexafluoropropyl (meth) acrylate, octafluoropropyl (meth) acrylate, octafluoropropyl (meth) acrylate, and adamantyl mono(meth)acrylate;

di(meth)acrylates such as butanediol di(meth)acrylate, hexanediol di(meth)acrylate, ethoxylated hexanediol di(meth)acrylate, propoxylated hexanediol di(meth)acrylate, diethylene glycol di(meth)acrylate, polyethylene glycol di(meth)acrylate, polypropylene glycol di(meth)acrylate, neopentyl glycol di(meth)acrylate, ethoxylated neopentyl glycol di(meth)acrylate, and neopentyl glycol hydroxypivalate di(meth)acrylate;

tri(meth)acrylates such as trimethylolpropane tri(meth)acrylate, ethoxylated trimethylolpropane tri(meth)acrylate, propoxylated trimethylolpropane tri(meth)acrylate, tris(2-hydroxyethyl) isocyanurate tri(meth)acrylate, and glycerol tri(meth)acrylate;

tetra- or higher functional (meth)acrylates such as pentaerythritol tri(meth)acrylate, dipentaerythritol tri(meth)acrylate, ditrimethylolpropane tri(meth)acrylate, pentaerythritol tetra(meth)acrylate, ditrimethylolpropane tetra(meth)acrylate, dipentaerythritol tetra(meth)acrylate, dipentaerythritol penta(meth)acrylate, ditrimethylolpropane penta(meth)acrylate, dipentaerythritol hexa(meth)acrylate, and ditrimethylolpropane hexa(meth)acrylate; and

(meth)acrylates prepared by substituting part of the above-mentioned various multifunctional (meth)acrylates with an alkyl group or ε-caprolactone.

Examples of the urethane (meth)acrylate include urethane (meth)acrylates produced by the reaction of polyisocyanate compounds with hydroxyl-containing (meth)acrylate compounds.

Examples of the polyisocyanate compounds used for preparing the urethane (meth)acrylate include a variety of diisocyanate monomers and isocyanurate polyisocyanate compounds having an isocyanurate ring structure in the molecule thereof.

Examples of the diisocyanate monomers include aliphatic diisocyanates such as butane-1,4-diisocyanate, hexamethylene diisocyanate, 2,2,4-trimethylhexamethylene diisocyanate, 2,4,4-trimethylhexamethylene diisocyanate, xylylene diisocyanate, and m-tetramethylxylylene diisocyanate;

alicyclic diisocyanates such as cyclohexane-1,4-diisocyanate, isophorone diisocyanate, lysine diisocyanate, dicyclohexylmethane-4,4′-diisocyanate, 1,3-bis(isocyanatomethyl)cyclohexane, and methylcyclohexane diisocyanate; and

aromatic diisocyanates such as 1,5-naphthylene diisocyanate, 4,4′-diphenylmethane diisocyanate, 4,4′-diphenyldimethylmethane diisocyanate, 4,4′-dibenzyl diisocyanate, dialkyldiphenylmethane diisocyanate, tetraalkyldiphenylmethane diisocyanate, 1,3-phenylene diisocyanate, 1,4-phenylene diisocyanate, and tolylene diisocyanate.

Examples of the isocyanurate polyisocyanate compounds having an isocyanurate ring structure in the molecule thereof include reaction products of diisocyanate monomers with monoalcohols and/or diols. Examples of the diisocyanate monomers used in this reaction include the various diisocyanate monomers described above, which may be used alone or in combination. Examples of the monoalcohols used in the reaction include hexanol, octanol, n-decanol, n-undecanol, n-dodecanol, n-tridecanol, n-tetradecanol, n-pentadecanol, n-heptadecanol, n-octadecanol, and n-nonadecanol. Examples of the diols used in the reaction include ethylene glycol, diethylene glycol, propylene glycol, 1,3-propanediol, 1,4-butanediol, 1,3-butanediol, 3-methyl-1,3-butanediol, 1,5-pentanediol, neopentyl glycol, and 1,6-hexanediol. These monoalcohols and diols may be used alone or in combination.

Among these polyisocyanate compounds, diisocyanate monomers are preferred because they enable formation of a cured coating film with excellent toughness, and aliphatic diisocyanates and alicyclic diisocyanates are more preferred.

Examples of the hydroxyl-containing (meth)acrylate compounds used for preparing the urethane (meth)acrylate include aliphatic (meth)acrylate compounds, such as 2-hydroxyethyl acrylate, 2-hydroxypropyl acrylate, 4-hydroxybutyl acrylate, glycerol diacrylate, trimethylolpropane diacrylate, pentaerythritol triacrylate, and dipentaerythritol pentaacrylate, and

(meth)acrylate compounds having an aromatic ring in the molecular structure thereof, such as 4-hydroxyphenyl acrylate, β-hydroxyphenethyl acrylate, 4-hydroxyphenethyl acrylate, 1-phenyl-2-hydroxyethyl acrylate, 3-hydroxy-4-acetylphenyl acrylate, and 2-hydroxy-3-phenoxypropyl acrylate. These compounds may be used alone or in combination.

Among these (meth)acrylate compounds with hydroxyl groups, aliphatic (meth)acrylate compounds having two or more (meth)acryloyl groups in the molecular structure thereof, such as glycerol diacrylate, trimethylolpropane diacrylate, pentaerythritol triacrylate, and dipentaerythritol pentaacrylate, are preferred because such compounds enable formation of a cured coating film having an excellent toughness and high surface hardness. Aliphatic (meth)acrylate compounds having three or more (meth)acryloyl groups in the molecular structure thereof, such as pentaerythritol triacrylate and dipentaerythritol pentaacrylate, are more preferred because these compounds enable formation of a cured coating film having a higher surface hardness.

The urethane (meth)acrylate may be produced, for example, by the reaction of the polyisocyanate compound with the hydroxyl-containing (meth)acrylate compound in the temperature range of 20° C. to 120° C. optionally with a well-known urethanization catalyst. In the reaction, the molar ratio [(NCO)/(OH)] of the isocyanate groups of the polyisocyanate compound to the hydroxyl groups of the hydroxyl-containing (meth)acrylate compound is from 1/0.95 to 1/1.05.

In the preparation of the urethane (meth)acrylate from the polyisocyanate compound and the (meth)acrylate compound having one hydroxyl group in the molecular structure thereof, the reaction may be carried out in a system containing an acrylate compound such as pentaerythritol tetra(meth)acrylate or dipentaerythritol hexa(meth)acrylate. Specific examples of the urethane (meth)acrylate prepared in this manner include urethane (meth)acrylate prepared by the reaction of a material containing the polyisocyanate compound, pentaerythritol tri(meth)acrylate, and pentaerythritol tetra(meth)acrylate and urethane acrylate prepared by the reaction of a material containing the polyisocyanate compound, dipentaerythritol penta(meth)acrylate, and dipentaerythritol hexa(meth)acrylate.

The weight average molecular weight (Mw) of the urethane (meth)acrylate prepared as described above is preferably in the range of 800 to 20,000, and more preferably 900 to 1,000.

These compounds may be used alone or in combination. In particular, tri- or higher functional (meth)acrylate monomers or tri- or higher functional urethane (meth)acrylates are preferred because they enable formation of a coating film having a further enhanced hardness. Preferred tri- or higher functional (meth)acrylate monomers are pentaerythritol tri(meth)acrylate, pentaerythritol tetra(meth)acrylate, dipentaerythritol penta(meth)acrylate, and dipentaerythritol hexa(meth)acrylate. Preferred tri- or higher functional urethane (meth)acrylates are urethane (meth)acrylates prepared by the reaction of diisocyanate compounds with hydroxyl-containing (meth)acrylate compounds having two or more (meth)acryloyl groups in the molecular structures thereof, such as glycerol diacrylate, trimethylolpropane diacrylate, pentaerythritol triacrylate, and dipentaerythritol pentaacrylate. More preferred ones are urethane (meth)acrylates prepared by the reaction of diisocyanate compounds with hydroxyl-containing (meth)acrylate compounds having three or more (meth)acryloyl groups.

The compound (B) having a (meth)acryloyl group, which is used in the present invention, may be the acrylic polymer (X) having a (meth)acryloyl group in the molecular structure thereof as described above; in particular, an acrylic polymer having a weight average molecular weight (Mw) ranging from 3,000 to 80,000 is preferred in terms of the surface hardness and scratch resistance of a coating film to be formed.

When the acrylic polymer (X) having a (meth)acryloyl group in the molecular structure thereof has a weight average molecular weight (Mw) ranging from 3,000 to 80,000, the fine particles (A) can be steadily dispersed, which leads to an enhancement in the storage stability of the resin composition. In particular, the weight average molecular weight (Mw) is preferably in the range of 8,000 to 50,000, and more preferably 10,000 to 45,000; at such a weight average molecular weight, the fine particles (A) have a better dispersibility, and the active-energy-ray-curable resin composition has a viscosity suitable for coating.

In the present invention, the weight average molecular weight (Mw) is measured by gel permeation chromatography (GPC) under the following conditions.

Measurement equipment: HLC-8220 manufactured by Tosoh Corporation

Columns: Guard Column H_{XL}-H manufactured by Tosoh Corporation
+TSKgel G5000H_{XL} manufactured by Tosoh Corporation
+TSKgel G4000H_{XL} manufactured by Tosoh Corporation
+TSKgel G3000H_{XL} manufactured by Tosoh Corporation
+TSKgel G2000H_{XL} manufactured by Tosoh Corporation

Detector: RI (differential refractometer)

Data processing: SC-8010 manufactured by Tosoh Corporation

Measurement conditions: Column temperature: 40° C.
Eluent: Tetrahydrofuran
Flow rate: 1.0 ml/min

Standards: Polystyrene

Sample: 0.4 mass % of a tetrahydrofuran solution in terms of the resin solid content was filtered through a microfilter (100 μl)

The (meth)acryloyl equivalent of the acrylic polymer (X) having a (meth)acryloyl group in the molecular structure thereof is preferably in the range of 220 g/eq to 1650 g/eq, and more preferably 240 g/eq to 1100 g/eq because it enables formation of a cured coating film having a high surface hardness and excellent resistance to curling on curing thereof. The (meth)acryloyl equivalent is further preferably in the range of 350 g/eq to 800 g/eq, and especially preferably 380 g/eq to 650 g/eq because it enables production of an active-energy-ray-curable resin composition that is excellent in temporal stability.

An example of the acrylic polymer (X) having a (meth)acryloyl group in the molecular structure thereof is a polymer produced through the reaction of an acrylic polymer (Y) prepared by polymerization of, as an essential component, a compound (y) having a reactive functional group and a (meth)acryloyl group with a compound (z) having a (meth)acryloyl group and a functional group that can react with the reactive functional group of the compound (y).

Specific examples thereof include an acrylic polymer (X1) produced through the reaction of an acrylic polymer (Y1) prepared by polymerization of, as an essential component, a compound (y1) having an epoxy group and a (meth)acryloyl group with a compound (z1) having a carboxyl group and a (meth)acryloyl group; an acrylic polymer (X2) produced through the reaction of an acrylic polymer (Y2) prepared by polymerization of, as an essential component, a compound (y2) having a carboxyl group and a (meth)acryloyl group with a compound (z2) having an epoxy group and a (meth)acryloyl group; and an acrylic polymer (X3) produced through the reaction of an acrylic polymer (Y3) prepared by polymerization of, as an essential component, a compound (y3) having a hydroxyl group and a (meth)acryloyl group with a compound (z3) having an isocyanate group and a (meth)acryloyl group.

The acrylic polymer (X1) will now be described.

The acrylic polymer (Y1) used as a raw material of the acrylic polymer (X1) may be a homopolymer of the compound (y1) having an epoxy group and a (meth)acryloyl group or may be a copolymer thereof with another polymerizable compound (v1).

Examples of the compound (y1) having an epoxy group and a (meth)acryloyl group and used as a raw material of the acrylic polymer (Y1) include glycidyl (meth)acrylate, glycidyl α-ethyl(meth)acrylate, glycidyl α-n-propyl(meth)acrylate, glycidyl α-n-butyl(meth)acrylate, 3,4-epoxybutyl (meth)acrylate, 4,5-epoxypentyl (meth)acrylate, 6,7-epoxypentyl (meth)acrylate, 6,7-epoxypentyl α-ethyl(meth)acrylate, β-methylglycidyl (meth)acrylate, 3,4-epoxycyclohexyl (meth)acrylate, lactone-modified 3,4-epoxycyclohexyl (meth) acrylate, and vinylcyclohexene oxide. These compounds may be used alone or in combination. Among these compounds, glycidyl (meth)acrylate, glycidyl α-ethyl(meth)acrylate, and glycidyl α-n-propyl(meth)acrylate are preferred because the (meth)acryloyl equivalent of the acrylic polymer (X1) to be produced can be easily adjusted to be in the above-mentioned preferred range, and glycidyl (meth)acrylate is more preferred.

Examples of such another polymerizable compound (v1) that can be copolymerized with the compound (y1) having an epoxy group and a (meth)acryloyl group in the production of the acrylic polymer (Y1) include (meth)acrylic acid esters having an alkyl group with 1 to 22 carbon atoms, such as methyl (meth)acrylate, ethyl (meth)acrylate, propyl (meth)acrylate, n-butyl (meth)acrylate, t-butyl (meth)acrylate, hexyl (meth)acrylate, heptyl (meth)acrylate, octyl (meth)acrylate, nonyl (meth)acrylate, decyl (meth)acrylate, dodecyl (meth)acrylate, tetradecyl (meth)acrylate, hexadecyl (meth)acrylate, stearyl (meth)acrylate, octadecyl (meth)acrylate, and docosyl (meth) acrylate;

(meth)acrylic acid esters having an alicyclic alkyl group, such as cyclohexyl (meth)acrylate, isobornyl (meth) acrylate, dicyclopentanyl (meth) acrylate, and dicyclopentenyloxyethyl (meth) acrylate;

(meth)acrylic acid esters having an aromatic ring, such as benzoyloxyethyl (meth)acrylate, benzyl (meth)acrylate, phenylethyl (meth) acrylate, phenoxyethyl (meth) acrylate, phenoxydiethylene glycol (meth)acrylate, and 2-hydroxy-3-phenoxypropyl (meth) acrylate;

acrylic acid esters having a hydroxyalkyl group, such as hydroxyethyl (meth)acrylate, hydroxypropyl (meth)acrylate, hydroxybutyl (meth) acrylate, glycerol (meth) acrylate, lactone-modified hydroxyethyl (meth)acrylate, and (meth)acrylic acid esters having a polyalkylene glycol group, such as polyethylene glycol (meth)acrylate and polypropylene glycol (meth) acrylate;

unsaturated dicarboxylic acid esters such as dimethyl fumarate, diethyl fumarate, dibutyl fumarate, dimethyl itaconate, dibutyl itaconate, methyl ethyl fumarate, methyl butyl fumarate, and methyl ethyl itaconate;

styrene derivetives such as styrene, α-methylstyrene, and chlorostyrene;

diene compounds such as butadiene, isoprene, piperylene, and dimethylbutadiene;

vinyl halides and vinylidene halides such as vinyl chloride and vinyl bromide;

unsaturated ketones such as methyl vinyl ketone and butyl vinyl ketone;

vinyl esters such as vinyl acetate and vinyl butyrate;

vinyl ethers such as methyl vinyl ether and butyl vinyl ether;

vinyl cyanides such as acrylonitrile, methacrylonitrile, and vinylidene cyanide;

acrylamide and alkyd-substituted amides thereof;

N-substituted maleimides such as N-phenylmaleimide and N-cyclohexylmaleimide;

fluorine-containing α-olefins such as vinyl fluoride, vinylidene fluoride, trifluoroethylene, chlorotrifluoroethylene, bromotrifluoroethylene, pentafluoropropylene, and hexafluoropropylene;

(per)fluoroalkyl perfluorovinyl ethers having a (per)fluoroalkyl group with 1 to 18 carbon atoms, such as trifluoromethyl trifluorovinyl ether, pentafluoroethyl trifluorovinyl ether, and heptafluoropropyl trifluorovinyl ether;

(per)fluoroalkyl (meth)acrylates having a (per)fluoroalkyl group with 1 to 18 carbon atoms, such as 2,2,2-trifluoroethyl (meth)acrylate, 2,2,3,3-tetrafluoropropyl (meth)acrylate, 1H,1H,5H-octafluoropentyl (meth) acrylate, 1H,1H,2H,2H-heptadecafluorodecyl (meth) acrylate, and perfluoroethyloxyethyl (meth) acrylate;

silyl-containing (meth)acrylates such as 3-methacryloxypropyltrimethoxysilane; and

N,N-dialkylaminoalkyl (meth)acrylates such as N,N-dimethylaminoethyl (meth) acrylate, N,N-diethylaminoethyl (meth) acrylate, and N,N-diethylaminopropyl (meth) acrylate. These compounds may be used alone or in combination. Among these, (meth)acrylic acid esters having an alkyl group with 1 to 22 carbon atoms and (meth)acrylic acid esters having an alicyclic alkyl group are preferred because the (meth)acryloyl equivalent of the acrylic polymer (X1) to be produced can be easily adjusted to be in the above-mentioned preferred range and because a cured coating film to be formed has a high hardness and excellent toughness; and (meth)acrylic acid esters having an alkyl group with 1 to 22 carbon atoms are more preferred. In particular, methyl (meth)acrylate, ethyl (meth)acrylate, propyl (meth)acrylate, n-butyl (meth)acrylate, t-butyl (meth)acrylate, cyclohexyl (meth)acrylate, and isobornyl (meth)acrylate are especially preferred.

As described above, the acrylic polymer (Y1) may be a homopolymer of the compound (y1) having an epoxy group and a (meth)acryloyl group or may be a copolymer of the compound (y1) having an epoxy group and a (meth)acryloyl group with another polymerizable compound (v1) explained above. In particular, the polymer is preferably prepared by copolymerization at a mass ratio [compound (y1) having epoxy group and (meth)acryloyl group]:[another polymerizable compound (v1)] of 10/90 to 90/10, and more preferably 15/85 to 80/20 because such a polymer enables the (meth)acryloyl equivalent of the resulting acrylic polymer (X1) to be easily adjusted to be in a preferred range and contributes to formation of a cured coating film having a high surface hardness and an excellent resistance to curling on curing thereof. The mass ratio is further preferably in the range of 20/80 to 50/50, and especially preferably 25/75 to 45/55 because it enables production of an active-energy-ray-curable resin composition that is excellent in temporal stability.

The acrylic polymer (Y1) has an epoxy group derived from the compound (y1). The epoxy equivalent of the acrylic polymer (Y1) is preferably in the range of 150 to 1600 g/eq, more preferably 170 to 1100 g/eq, further preferably 270 to 750 g/eq, and especially preferably 300 to 550 g/eq in order to make it easy to adjust the acryloyl equivalent of the resulting acrylic polymer (X1) to be from 220 to 1650 g/eq.

The acrylic polymer (Y1) can be prepared, for example, by addition polymerization of the compound (y1) alone or in combination with the compound (v1) in the presence of a polymerization initiator in the temperature range of 60° C. to 150° C. The resulting acrylic polymer (Y1) may be, for example, a random copolymer, a block copolymer, or a graft copolymer. The polymerization may be performed, for example, by bulk polymerization, solution polymerization, suspension polymerization, or emulsion polymerization. Among these, solution polymerization is preferred because the preparation of the acrylic polymer (Y1) and the following reaction of the acrylic polymer (Y1) with the compound (z1) having a carboxyl group and a (meth)acryloyl group can be continuously performed.

In the case where the acrylic polymer (Y1) is prepared by solution polymerization, it may be performed using a solvent having a boiling point of 80° C. or higher in view of the reaction temperature. Examples of such solvents include ketone solvents such as methyl ethyl ketone, methyl n-propyl ketone, methyl isopropyl ketone, methyl n-butyl ketone, methyl isobutyl ketone, methyl n-amyl ketone, methyl n-hexyl ketone, diethyl ketone, ethyl n-butyl ketone, di-n-propyl ketone, diisobutyl ketone, cyclohexanone, and phorone;

ether solvents such as n-butyl ether, diisoamyl ether, and dioxane;

glycol ether solvents such as ethylene glycol monomethyl ether, ethylene glycol dimethyl ether, ethylene glycol monoethyl ether, ethylene glycol diethyl ether, ethylene glycol monopropyl ether, ethylene glycol monoisopropyl ether, ethylene glycol monobutyl ether, diethylene glycol monomethyl ether, diethylene glycol dimethyl ether, diethylene glycol monoethyl ether, diethylene glycol diethyl ether, diethylene glycol monoisopropyl ether, diethylene glycol monobutyl ether, triethylene glycol monomethyl ether, triethylene glycol dimethyl ether, propylene glycol monomethyl ether, propylene glycol dimethyl ether, propylene glycol monopropyl ether, propylene glycol monobutyl ether, dipropylene glycol monomethyl ether, and dipropylene glycol dimethyl ether;

ester solvents such as n-propyl acetate, isopropyl acetate, n-butyl acetate, n-amyl acetate, ethylene glycol monomethyl ether acetate, ethylene glycol monoethyl ether acetate, diethylene glycol monomethyl ether acetate, diethylene glycol monoethyl ether acetate, propylene glycol monomethyl ether acetate, and ethyl-3-ethoxy propionate;

alcohol solvents such as isopropyl alcohol, n-butyl alcohol, isobutyl alcohol, diacetone alcohol, 3-methoxy-1-propanol, 3-methoxy-1-butanol, and 3-methyl-3-methoxybutanol; and

hydrocarbon solvents such as toluene, xylene, SOLVESSO 100, SOLVESSO 150, SWASOL 1800, SWASOL 310, ISOPAR E, ISOPAR G, Exxon Naphtha No. 5, and Exxon Naphtha No. 6. These solvents may be used alone or in combination.

Among these solvents, ketone solvents, such as methyl ethyl ketone and methyl isobutyl ketone, and glycol ether solvents such as propylene glycol monomethyl ether are preferred because they enable production of the acrylic polymer (Y1) having an excellent solubility.

Examples of catalysts used in the production of the acrylic polymer (Y1) include azo compounds such as 2,2′-azobisisobutyronitrile, 2,2′-azobis(2,4-dimethylvaleronitrile), and 2,2′-azobis(4-methoxy-2,4-dimethylvaleronitrile) and hydrogen peroxide and organic peroxides such as benzoyl peroxide, lauroyl peroxide, t-butyl peroxypivalate, t-butyl peroxyethylhexanoate, 1,1′-bis(t-butylperoxy)cyclohexane, t-amyl peroxy-2-ethylhexanoate, and t-hexyl peroxy-2-ethylhexanoate.

In the case where the catalyst is a peroxide, it may be used in combination with a reducing agent, namely in the form of a redox initiator.

Examples of the compound (z1) having a carboxyl group and a (meth)acryloyl group, which is used as a raw material of the acrylic polymer (X1), include carboxyl-containing polyfunctional (meth)acrylates prepared by the reaction of unsaturated monocarboxylic acids such as (meth)acrylic acid, (acryloyloxy)acetic acid, 2-carboxyethyl acrylate, 3-carboxypropyl acrylate, 1-[2-(acryloyloxy)ethyl] succinate, 1-(2-acryloyloxyethyl) phthalate, 2-(acryloyloxy)ethyl hydrogen hexahydrophthalate, and lactone-modified derivatives thereof; unsaturated dicarboxylic acids such as maleic acid; and acid anhydrides such as succinic anhydride and maleic anhydride with hydroxyl-containing polyfunctional (meth)acrylate monomers such as pentaerythritol triacrylate. These compounds may be used alone or in combination. Among these, (meth)acrylic acid, (acryloyloxy)acetic acid, 2-carboxyethyl acrylate, and 3-carboxypropyl acrylate are preferred because the (meth)acryloyl equivalent of the acrylic polymer (X1) can be easily adjusted to be in the above-mentioned preferred range, and (meth)acrylic acid are especially preferred.

The acrylic polymer (X1) is prepared by the reaction of the acrylic polymer (Y1) with the compound (z1) having a carboxyl group and a (meth)acryloyl group. This reaction may be performed, for example, as follows: the acrylic polymer (Y1) is prepared by solution polymerization, the compound (z1) having a carboxyl group and a (meth)acryloyl group is added to the reaction system, and the mixture is subjected to the reaction in the temperature range of 60° C. to 150° C. optionally with the aid of a catalyst such as triphenylphosphine. The (meth)acryloyl equivalent of the acrylic polymer (X1) is preferably in the range of 220 to 1650 g/eq and can be controlled on the basis of the reaction ratio of the compound (z1) having a carboxyl group and a (meth)acryloyl group to the acrylic polymer (Y1). The reaction is normally carried out such that the carboxyl group of the compound (z1) is in the range of 0.8 to 1.1 mol per mole of the epoxy group of the acrylic polymer (Y1), so that the (meth)acryloyl equivalent of the acrylic polymer (X1) to be produced can be easily adjusted to be in the above-mentioned preferred range.

The acrylic polymer (X1) produced in this manner has hydroxyl groups generated by the reaction of epoxy groups with carboxyl groups in the molecular structure thereof. In the present invention, these hydroxyl groups may be optionally subjected to addition reaction with a compound (w) having an isocyanate group and a (meth)acryloyl group to adjust the acryloyl equivalent of the acrylic polymer (X1) to be in a preferred range. An acrylic polymer (X1′) can be prepared in this manner and used as the acrylic polymer (X) in the present invention, as is the acrylic polymer (X1).

The compound (w) having an isocyanate group and a (meth)acryloyl group may be, for instance, any of compounds represented by General Formula 1. Examples of such compounds include monomers having one isocyanate group and one (meth)acryloyl group, monomers having one isocyanate group and two (meth)acryloyl groups, monomers having one isocyanate group and three (meth)acryloyl groups, monomers having one isocyanate group and four (meth)acryloyl groups, and monomers having one isocyanate group and five (meth)acryloyl groups.

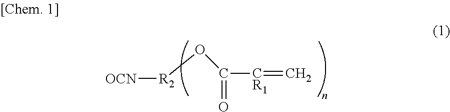

In General Formula (1), R₁ is a hydrogen atom or a methyl group, R₂ is an alkylene group having 2 to 4 carbon atoms, and n is an integer from 1 to 5.

Specific examples of commercially available products of the compounds (w) having an isocyanate group and a (meth)acryloyl group include 2-acryloyloxyethyl isocyanate (e.g., trade name “Karenz AOI”, manufactured by Showa Denko K.K.), 2-metacryloyloxyethyl isocyanate (e.g., trade name “Karenz MOI”, manufactured by Showa Denko K.K.), and 1,1-bis(acryloyloxymethyl)ethyl isocyanate (e.g., trade name “Karenz BEI”, manufactured by Showa Denko K.K.).

Other examples of the compounds (w) include compounds prepared by adding a hydroxyl-containing (meth)acrylate compound to one of the isocyanate groups of a diisocyanate compound. Examples of the diisocyanate compound used in this reaction include aliphatic diisocyanates such as butane-1,4-diisocyanate, hexamethylene diisocyanate, 2,2,4-trimethylhexamethylene diisocyanate, 2,4,4-trimethylhexamethylene diisocyanate, xylylene diisocyanate, and m-tetramethylxylylene diisocyanate;

alicyclic diisocyanates such as cyclohexane-1,4-diisocyanate, isophorone diisocyanate, lysine diisocyanate, dicyclohexylmethane-4,4′-diisocyanate, 1,3-bis(isocyanatomethyl)cyclohexane, and methylcyclohexane diisocyanate; and

aromatic diisocyanates such as 1,5-naphthylene diisocyanate, 4,4′-diphenylmethane diisocyanate, 4,4′-diphenyldimethylmethane diisocyanate, 4,4′-dibenzyl diisocyanate, dialkyldiphenylmethane diisocyanate, tetraalkyldiphenylmethane diisocyanate, 1,3-phenylene diisocyanate, 1,4-phenylene diisocyanate, and tolylene diisocyanate. These compounds may be used alone or in combination.

Examples of the hydroxyl-containing (meth)acrylate compound used in this reaction include aliphatic (meth)acrylate compounds such as 2-hydroxyethyl acrylate, 2-hydroxypropyl acrylate, 4-hydroxybutyl acrylate, glycerol diacrylate, trimethylolpropane diacrylate, pentaerythritol triacrylate, and dipentaerythritol pentaacrylate; and

(meth)acrylate compounds having an aromatic ring in the molecular structure thereof, such as 4-hydroxyphenyl acrylate, β-hydroxyphenethyl acrylate, 4-hydroxyphenethyl acrylate, 1-phenyl-2-hydroxyethyl acrylate, 3-hydroxy-4-acetylphenyl acrylate, and 2-hydroxy-3-phenoxypropyl acrylate. These compounds may be used alone or in combination.

The reaction of the acrylic polymer (X1) with the compound (w) having an isocyanate group and a (meth)acryloyl group, for example, may be performed as follows: the compound (w) having an isocyanate group and a (meth)acryloyl group is added dropwise to the system containing the acrylic polymer (X1) prepared by the process described above, and then the resulting product is heated to 50 to 120° C.

Of the acrylic polymers (X1) and (X1′), the molecules of the acrylic polymer (X1) contain more hydroxyl groups, and the interaction of the hydroxyl groups with the inorganic fine particles (A) enables the dispersibility of the inorganic fine particles (A) to be enhanced; thus, the acrylic polymer (X1) is preferred.

The acrylic polymer (X2) will now be described.

The acrylic polymer (Y2) used as a raw material of the acrylic polymer (X2) may be a homopolymer of the compound (y2) having a carboxyl group and a (meth)acryloyl group or may be a copolymer thereof with another polymerizable compound (v2).

Examples of the compound (y2) having a carboxyl group and a (meth)acryloyl group, which is used as a raw material of the acrylic polymer (Y2), include carboxyl-containing polyfunctional (meth)acrylates prepared by the reaction of unsaturated monocarboxylic acids such as (meth)acrylic acid, (acryloyloxy)acetic acid, 2-carboxyethyl acrylate, 3-carboxypropyl acrylate, 1-[2-(acryloyloxy)ethyl] succinate, 1-(2-acryloyloxyethyl) phthalate, 2-(acryloyloxy)ethyl hydrogen hexahydrophthalate, and lactone-modified derivatives thereof; unsaturated dicarboxylic acids such as maleic acid; and acid anhydrides such as succinic anhydride and maleic anhydride with hydroxyl-containing polyfunctional (meth)acrylate monomers such as pentaerythritol triacrylate. These compounds may be used alone or in combination. Among these, (meth)acrylic acid, (acryloyloxy)acetic acid, 2-carboxyethyl acrylate, and 3-carboxypropyl acrylate are preferred because the (meth)acryloyl equivalent of the acrylic polymer (X2) can be easily adjusted to be in the above-mentioned preferred range, and (meth)acrylic acid are especially preferred.

Examples of such another polymerizable compound (v2) that can be copolymerized with the compound (y2) having a carboxyl group and a (meth)acryloyl group in the production of the acrylic polymer (Y2) include the various compounds described as examples of the compound (v1). These compounds may be used alone or in combination. Among these compounds, (meth)acrylic acid esters having an alkyl group with 1 to 22 carbon atoms and (meth)acrylic acid esters having an alicyclic alkyl group are preferred because they enable the (meth)acryloyl equivalent of the resulting acrylic polymer (X2) to be easily adjusted to be in the above-mentioned preferred range and enables formation of a cured coating film having a high hardness and excellent toughness, and (meth)acrylic acid esters having an alkyl group with 1 to 22 carbon atoms are more preferred. In particular, methyl (meth)acrylate, ethyl (meth)acrylate, propyl (meth)acrylate, n-butyl (meth)acrylate, and t-butyl (meth)acrylate are especially preferred.

As described above, the acrylic polymer (Y2) may be a homopolymer of the compound (y2) having a carboxyl group and a (meth)acryloyl group or may be a copolymer of the compound (y2) having a carboxyl group and a (meth)acryloyl group with another polymerizable compounds (v2) explained above. In particular, the polymer is preferably prepared by copolymerization at a mass ratio [compound (y2) having carboxyl group and (meth)acryloyl group]:[another polymerizable compound (v2)] from 10/90 to 90/10, more preferably 15/85 to 80/20, further preferably 20/80 to 50/50, and especially preferably 25/75 to 45/55 because such a polymer enables the (meth)acryloyl equivalent of the resulting acrylic polymer (X2) to be easily adjusted to be in a preferred range.

The acrylic polymer (Y2) can be prepared, for example, by addition polymerization of the compound (y2) alone or in combination with the compound (v2) in the presence of a polymerization initiator in the temperature range of 60° C. to 150° C. The resulting acrylic polymer (Y2) may be, for example, a random copolymer, a block copolymer, or a graft copolymer. The polymerization may be performed, for example, by bulk polymerization, solution polymerization, suspension polymerization, or emulsion polymerization. Among these, solution polymerization is preferred because the preparation of the acrylic polymer (Y2) and the following reaction of the acrylic polymer (Y2) with the compound (z1) having an epoxy group and a (meth)acryloyl group can be continuously performed.

In the case where the acrylic polymer (Y2) is produced by solution polymerization, it may be performed using the various solvents described as examples of the solvents used in solution polymerization for the production of the acrylic polymer (Y1). These solvents may be used alone or in combination. Among these solvents, ketone solvents such as methyl ethyl ketone and methyl isobutyl ketone are preferred because they enable the resulting acrylic polymer (Y2) to have an excellent solubility.

Examples of catalysts used in the production of the acrylic polymer (Y2) include the various catalysts described as examples of the catalysts used in the production of the acrylic polymer (Y1).

Examples of the compound (z2) having an epoxy group and a (meth)acryloyl group, which is used as a raw material of the acrylic polymer (X2), include glycidyl (meth)acrylate, glycidyl α-ethyl(meth)acrylate, glycidyl α-n-propyl(meth)acrylate, glycidyl α-n-butyl(meth)acrylate, 3,4-epoxybutyl (meth) acrylate, 4,5-epoxypentyl (meth) acrylate, 6,7-epoxypentyl (meth)acrylate, 6,7-epoxypentyl α-ethyl(meth)acrylate, β-methylglycidyl (meth) acrylate, 3,4-epoxycyclohexyl (meth)acrylate, lactone-modified 3,4-epoxycyclohexyl (meth)acrylate, and vinylcyclohexene oxide. These compounds may be used alone or in combination. Among these compounds, glycidyl (meth)acrylate, glycidyl α-ethyl(meth)acrylate, and glycidyl α-n-propyl(meth)acrylate are preferred because they enable the (meth)acryloyl equivalent of the resulting acrylic polymer (X2) to be easily adjusted to be in the above-mentioned preferred range.

The acrylic polymer (X2) is prepared by the reaction of the acrylic polymer (Y2) with the compound (z2) having an epoxy group and a (meth)acryloyl group. This reaction may be performed, for example, as follows: the acrylic polymer (Y2) is prepared by solution polymerization, the compound (z2) having an epoxy group and a (meth)acryloyl group is added to the reaction system, and the mixture is subjected to the reaction in the temperature range of 60° C. to 150° C. optionally with the aid of a catalyst such as triphenylphosphine. The (meth)acryloyl equivalent of the acrylic polymer (X2) is preferably in the range of 220 to 1650 g/eq and can be controlled on the basis of the reaction ratio of the compound (z2) having an epoxy group and a (meth)acryloyl group to the acrylic polymer (Y2). The reaction is normally carried out such that the epoxy group of the compound (z2) is in the range of 0.9 to 1.25 mol per mole of the carboxyl group of the acrylic polymer (Y2), so that the (meth)acryloyl equivalent of the acrylic polymer (X2) to be produced can be easily adjusted to be in the above-mentioned preferred range.

The acrylic polymer (X2) prepared in this manner has hydroxyl groups generated by the reaction of carboxyl groups with epoxy groups in the molecular structure thereof. In the present invention, these hydroxyl groups may be optionally subjected to addition reaction with the compound (w) having an isocyanate group and a (meth)acryloyl group to adjust the acryloyl equivalent of the acrylic polymer (X2) to be in a preferred range. An acrylic polymer (X2′) can be prepared in this manner and used as the acrylic polymer (X) in the present invention, as is the acrylic polymer (X2).

The reaction of the acrylic polymer (X2) with the compound (w) having an isocyanate group and a (meth)acryloyl group, for example, may be performed as follows: the compound (w) having an isocyanate group and a (meth)acryloyl group is added dropwise to the system containing the acrylic polymer (X2) prepared by the process described above, and then the resulting product is heated to 50 to 120° C.

Of the acrylic polymers (X2) and (X2′), the molecules of the acrylic polymer (X2) contain more hydroxyl groups, and the interaction of the hydroxyl groups with the inorganic fine particles (A) enables the dispersibility of the inorganic fine particles (A) to be enhanced; thus, the acrylic polymer (X2) is preferred.

The acrylic polymer (X3) will now be described.

The acrylic polymer (Y3) used as a raw material of the acrylic polymer (X3) may be a homopolymer of the compound (y3) having a hydroxyl group and a (meth)acryloyl group or may be a copolymer thereof with another polymerizable compound (v3).

Examples of the compound (y3) having a hydroxyl group and a (meth)acryloyl group, which is used as a raw material of the acrylic polymer (Y3), include 2-hydroxyethyl acrylate, 2-hydroxypropyl acrylate, 4-hydroxybutyl acrylate, 2,3-dihydroxypropyl acrylate, 2-hydroxyethyl methacrylate, 2-hydroxypropyl methacrylate, 4-hydroxybutyl methacrylate, and 2,3-dihydroxypropyl methacrylate. These compounds may be used alone or in combination. Among these, 2-hydroxyethyl acrylate and 2-hydroxypropyl acrylate are preferred because they enable the (meth)acryloyl equivalent of the acrylic polymer (X3) to be easily adjusted to be in the above-mentioned preferred range and contribute to production of the acrylic polymer (X3) which has a high hydroxyl value and in which the inorganic fine particles (A) can be well dispersed.

Examples of such another polymerizable compound (v3) that can be copolymerized with the compound (y3) having a hydroxyl group and a (meth)acryloyl group in the production of the acrylic polymer (Y3) include the various compounds described as examples of the compound (v1). These compounds may be used alone or in combination. Among these compounds, (meth)acrylic acid esters having an alkyl group with 1 to 22 carbon atoms and (meth)acrylic acid esters having an alicyclic alkyl group are preferred because they enable the (meth)acryloyl equivalent of the resulting acrylic polymer (X3) to be easily adjusted to be in the above-mentioned preferred range and contribute to formation of a cured coating film having a high hardness and excellent toughness, and (meth)acrylic acid esters having an alkyl group with 1 to 22 carbon atoms are more preferred. In particular, methyl (meth)acrylate, ethyl (meth)acrylate, propyl (meth)acrylate, n-butyl (meth)acrylate, and t-butyl (meth)acrylate are especially preferred.

As described above, the acrylic polymer (Y3) may be a homopolymer of the compound (y3) having a hydroxyl group and a (meth)acryloyl group or may be a copolymer thereof with another polymerizable compound (v3). In particular, the polymer is preferably prepared by copolymerization at a mass ratio [compound (y3) having hydroxyl group and (meth)acryloyl group]:[another polymerizable compound (v3)] of 10/90 to 90/10, more preferably 15/85 to 80/20, further preferably 20/80 to 50/50, and especially preferably 25/75 to 45/55 because such a polymer enables the (meth)acryloyl equivalent of the resulting acrylic polymer (X3) to be easily adjusted to be in a preferred range.

The acrylic polymer (Y3) can be prepared, for example, by addition polymerization of the compound (y3) alone or in combination with the compound (v3) in the presence of a polymerization initiator in the temperature range of 60° C. to 150° C. The resulting acrylic polymer (Y3) may be, for example, a random copolymer, a block copolymer, or a graft copolymer. The polymerization may be performed, for example, by bulk polymerization, solution polymerization, suspension polymerization, or emulsion polymerization. Among these, solution polymerization is preferred because the preparation of the acrylic polymer (Y3) and the following reaction of the acrylic polymer (Y3) with the compound (z3) having an isocyanate group and a (meth)acryloyl group can be continuously performed.

In the case where the acrylic polymer (Y3) is produced by solution polymerization, it may be performed using the various solvents described as examples of the solvents used in solution polymerization for the production of the acrylic polymer (Y1). These solvents may be used alone or in combination. Among these solvents, ketone solvents such as methyl ethyl ketone and methyl isobutyl ketone are preferred because they enable the resulting acrylic polymer (Y3) to have an excellent solubility.

Examples of catalysts used in the production of the acrylic polymer (Y3) include the various catalysts described as examples of the catalysts used in the production of the acrylic polymer (Y1).

Examples of the compound (z3) having an isocyanate group and a (meth)acryloyl group, which is used as a raw material of the acrylic polymer (X3), include the various compounds described as examples of the compound (w) having an isocyanate group and a (meth)acryloyl group. These compounds may be used alone or in combination. Among these compounds, compounds having two or more (meth)acryloyl groups per molecule, specifically 1,1-bis(acryloyloxymethyl)ethyl isocyanate, are preferred because they allow the resulting acrylic polymer (X3) to be a higher functional compound and enable formation of a coating film having a higher hardness.

The acrylic polymer (X3) is prepared by the reaction of the acrylic polymer (Y3) with the compound (z3) having an isocyanate group and a (meth)acryloyl group. This reaction may be performed, for example, as follows: the acrylic polymer (Y3) is prepared by solution polymerization, the compound (z3) having an isocyanate group and a (meth)acryloyl group is added to the reaction system, and the mixture is subjected to the reaction in the temperature range of 50° C. to 120° C. optionally with the aid of a catalyst such as tin (II) octoate. The (meth)acryloyl equivalent of the acrylic polymer (X3) is preferably in the range of 220 to 1650 g/eq and can be controlled on the basis of the reaction ratio of the acrylic polymer (Y3) to the compound (z3) having an isocyanate group and a (meth)acryloyl group. The reaction is normally carried out such that the isocyanate group of the compound (z3) is in the range of 0.7 to 0.9 mol per mole of the hydroxyl group of the acrylic polymer (Y3), so that the (meth)acryloyl equivalent of the acrylic polymer (X3) to be produced can be easily adjusted to be in the above-mentioned preferred range.

The acrylic polymer (X) is preferably selected from the acrylic polymers (X1) and (X2) because they are well miscible with the fine silica particles (A) and enable the resulting dispersion to have excellent storage stability. The acrylic polymers (X1) and (X2) each preferably have a hydroxyl value ranging from 35 to 250 mgKOH/g, more preferably 50 to 230 mgKOH/g, further preferably 65 to 160 mgKOH/g, and especially preferably 80 to 150 mgKOH/g because such a hydroxyl value contributes to excellent dispersibility of the fine silica particles (A). In particular, the acrylic polymer (X1) is preferred because it is easy to be prepared, and an acrylic polymer prepared using glycidyl (meth)acrylate as the compound (y1) and (meth)acrylic acid as the compound (z1) is more preferred.

The active-energy-ray-curable resin composition of the present invention contains the fine silica particles (A) and the compound (B) having a (meth)acryloyl group as essential components, and the amount of the fine silica particles (A) is preferably in the range of 5 to 80 parts by mass relative to 100 parts by mass of the total of the amounts of these essential components. The amount of the fine silica particles (A) within such a range contributes to good resistance to curling on curing and good storage stability of the active-energy-ray-curable resin composition. In particular, the amount of the fine silica particles (A) is more preferably in the range of 30 to 60 parts by mass relative to 100 parts by mass of the total of the amounts of the essential components because it contributes to excellent storage stability of the resin composition and enables formation of a cured coating film having a high surface hardness, transparency, and resistance to curling thereof.

In the active-energy-ray-curable resin composition of the present invention, the compound (B) having a (meth)acryloyl group may be used alone or in the form of a mixture with another compound. It is preferred that proper use thereof be determined in view of adjustment of the viscosity of the composition that is to be applied and of the surface hardness of the intended coating film.

The resin composition of the present invention may optionally contain a dispersant. Examples of the dispersant include phosphoric acid ester compounds such as isopropyl acid phosphate, triisodecyl phosphite, and ethylene-oxide-modified phosphoric acid dimethacrylate. These compounds may be used alone or in combination. Among these compounds, ethylene-oxide-modified phosphoric acid dimethacrylate is preferred because it is excellent in promoting dispersion.

Examples of commercially available products of such dispersants include “KAYAMER PM-21” and “KAYAMER PM-2” manufactured by Nippon Kayaku Co., Ltd. and “LIGHT ESTER P-2M” manufactured by kyoeisha Chemical Co., Ltd.

In the case where the dispersant is used, the amount thereof is preferably from 0.5 to 5.0 parts by mass relative to 100 parts by mass of the resin composition of the present invention because it enables the resin composition to have a further enhanced storage stability.

The resin composition of the present invention may contain an organic solvent. The organic solvent may be, for instance, a solvent used in production of the acrylic polymer (X) by solution polymerization, and another solvent may be additionally used. Alternatively, the organic solvent used in production of the acrylic polymer (X) is removed, and then another solvent may be used. Specific examples of the solvent to be used include ketone solvents such as acetone, methyl ethyl ketone (MEK), and methyl isobutyl ketone (MIBK); cyclic ether solvents such as tetrahydrofuran (THF) and dioxolane; esters such as methyl acetate, ethyl acetate, and butyl acetate; aromatic solvents such as toluene and xylene; alcohol solvents such as carbitol, cellosolve, methanol, isopropanol, butanol, and propylene glycol monomethyl ether; and glycol ether solvents such as ethylene glycol monoethyl ether, ethylene glycol monobutyl ether, propylene glycol monomethyl ether, and propylene glycol monopropyl ether. These solvents may be used alone or in combination. Among these solvents, ketone solvents are preferred because they enable the resin composition to have an excellent storage stability and also excellent application properties when the composition is used in the form of a coating material, and methyl isobutyl ketone is more preferred.

The resin composition of the present invention may further contain additives such as ultraviolet absorbers, antioxidants, silicon-containing additives, organic beads, fluorine-containing additives, rheology control agents, defoamers, release agents, antistatic agents, antifogging agents, colorants, organic solvents, and inorganic fillers. The active-energy-ray-curable resin composition of the present invention enables formation of a coating film having an excellent surface smoothness without use of a leveling agent and therefore can be suitably used in applications in which the occurrence of bleed-out of a leveling agent is avoided; in an example of such applications, a coating film is formed of the composition of the present invention, and then a protective film and another coating film may be further formed thereon.

Examples of the ultraviolet absorbers include triazine derivatives such as 2-[4-{(2-hydroxy-3-dodecyloxypropyl)oxy}-2-hydroxyphenyl]-4,6-bis(2,4-dimethylphenyl)-1,3,5-triazine and 2-[4-[(2-hydroxy-3-tridecyloxypropyl)oxy]-2-hydroxyphenyl]-4,6-bis(2,4-dimethylphenyl)-1,3,5-triazine, 2-(2′-xanthenecarboxy-5′-methylphenyl)benzotriazole, 2-(2′-o-nitrobenzyloxy-5′-methylphenyl)benzotriazole, 2-xanthenecarboxy-4-dodecyloxybenzophenone, and 2-o-nitrobenzyloxy-4-dodecyloxybenzophenone.

Examples of the antioxidants include hindered phenol antioxidants, hindered amine antioxidants, organosulfur antioxidants, and phosphate antioxidants. These compounds may be used alone or in combination.

Examples of the silicon-containing additives include polyorganosiloxanes having an alkyl group or a phenyl group, polydimethylsiloxanes having a polyether-modified acrylic group, and polydimethylsiloxanes having a polyester-modified acrylic group, such as dimethylpolysiloxane, methylphenylpolysiloxane, cyclic dimethylpolysiloxane, methylhydrogenpolysiloxane, polyether-modified dimethylpolysiloxane copolymers, polyester-modified dimethylpolysiloxane copolymers, fluorine-modified dimethylpolysiloxane copolymers, and amino-modified dimethylpolysiloxane copolymers. These compounds may be used alone or in combination.

Examples of the organic beads include polymethyl methacrylate beads, polycarbonate beads, polystyrene beads, polyacrylic styrene beads, silicone beads, glass beads, acrylic beads, benzoguanamine resin beads, melamine resin beads, polyolefin resin beads, polyester resin beads, polyamide resin beads, polyimide resin beads, polyfluoroethylene resin beads, and polyethylene resin beads. These organic beads preferably have an average particle size ranging from 1 to 10 μm. These beads may be used alone or in combination.

Examples of the fluorine-containing additives include “MEGAFAC” series manufactured by DIC Corporation. These may be used alone or in combination.

Examples of the release agents include “Tego Rad 2200N”, “Tego Rad 2300”, and “Tego Rad 2100” each manufactured by Evonik Degussa GmbH; “UV3500” manufactured by BYK-Chemie GmbH; and “PAINTAD 8526” and “SH-29PA” each manufactured by Dow Corning Toray Co., Ltd. These may be used alone or in combination.

Examples of the antistatic agents include pyridinium, imidazolium, phosphonium, ammonium, and lithium salts of bis(trifluoromethanesulfonyl)imide and bis(fluorosulfonyl)imide. These compounds may be used alone or in combination.

The various additives are preferably used in such amounts that they are sufficiently effective but do not interfere with ultraviolet curing; specifically, the amounts are preferably in the range of 0.01 to 40 parts by mass relative to 100 parts by mass of the resin composition of the present invention.

The resin composition of the present invention further contains a photoinitiator. Examples of the photoinitiator include various benzophenones such as benzophenone, 3,3′-dimethyl-4-methoxybenzophenone, 4,4′-bisdimethylaminobenzophenone, 4,4′-bisdiethylaminobenzophenone, 4,4′-dichlorobenzophenone, Michler's ketone, and 3,3′,4,4′-tetra(t-butylperoxycarbonyl)benzophenone;

xanthones and thioxanthones such as xanthone, thioxanthone, 2-methylthioxanthone, 2-chlorothioxanthone, and 2,4-diethylthioxanthone; various acyloin ethers such as benzoin, benzoin methyl ether, benzoin ethyl ether, and benzoin isopropyl ether;

α-diketones such as benzil and diacetyl; sulfides such as tetramethylthiuram disulfide and p-tolyl disulfide; various benzoic acids such as 4-dimethylaminobenzoic acid and ethyl 4-dimethylaminobenzoate; and

3,3′-carbonyl-bis(7-diethylamino)coumarin, 1-hydroxycyclohexyl phenyl ketone, 2,2′-dimethoxy-1,2-diphenylethan-1-one, 2-methyl-1-[4-(methylthio)phenyl]-2-morpholinopropan-1-one, 2-benzyl-2-dimethylamino-1-(4-morpholinophenyl)-butan-1-one, 2-hydroxy-2-methyl-1-phenylpropan-1-one, 2,4,6-trimethylbenzoyldiphenylphosphine oxide, bis(2,4,6-trimethylbenzoyl)phenylphosphine oxide, 1-[4-(2-hydroxyethoxy)phenyl]-2-hydroxy-2-methyl-1-propan-1-one, 1-(4-isopropylphenyl)-2-hydroxy-2-methylpropan-1-one, 1-(4-dodecylphenyl)-2-hydroxy-2-methylpropan-1-one, 4-benzoyl-4′-methyldimethyl sulfide, 2,2′-diethoxyacetophenone, benzyl dimethyl ketal, benzyl β-methoxyethyl acetal, methyl o-benzoylbenzoate, bis(4-dimethylaminophenyl) ketone, p-dimethylaminoacetophenone, α,α-dichloro-4-phenoxyacetophenone, pentyl-4-dimethylaminobenzoate, 2-(o-chlorophenyl)-4,5-diphenylimidazolyl dimer, 2,4-bis-trichloromethyl-6-[di-(ethoxycarbonylmethyl)amino]phenyl-S-triazine, 2,4-bis-trichloromethyl-6-(4-ethoxyl)phenyl-S-triazine, 2,4-bis-trichloromethyl-6-(3-bromo-4-ethoxy)phenyl-S-triazineanthraquinone, 2-t-butylanthraquinone, 2-amylanthraquinone, and β-chloroanthraquinone. These compounds may be used alone or in combination.

Among these photoinitiators, using the following ones alone or in the form of a mixture is preferred because it enables production of a coating material that has high curability and that is active for light in a wider wavelength range: 1-hydroxycyclohexyl phenyl ketone, 2-hydroxy-2-methyl-1-phenylpropan-1-one, 1-[4-(2-hydroxyethoxy)phenyl]-2-hydroxy-2-methyl-1-propan-1-one, thioxanthone and thioxanthone derivatives, 2,2′-dimethoxy-1,2-diphenylethan-1-one, 2,4,6-trimethylbenzoyldiphenylphosphine oxide, bis(2,4,6-trimethylbenzoyl)phenylphosphine oxide, 2-methyl-1-[4-(methylthio)phenyl]-2-morpholino-1-propanone, and 2-benzyl-2-dimethylamino-1-(4-morpholinophenyl)-butan-1-one.

Examples of commercially available products of the photoinitiators include “IRGACURE 184”, “IRGACURE 149”, “IRGACURE 261”, “IRGACURE 369”, “IRGACURE 500”, “IRGACURE 651”, “IRGACURE 754”, “IRGACURE 784”, “IRGACURE 819”, “IRGACURE 907”, “IRGACURE 1116”, “IRGACURE 1664”, “IRGACURE 1700”, “IRGACURE 1800”, “IRGACURE 1850”, “IRGACURE 2959”, “IRGACURE 4043”, and “Darocur 1173” manufactured by Ciba Specialty Chemicals; “Lucirin TPO” manufactured by BASF SE; “KAYACURE DETX”, “KAYACURE MBP”, “KAYACURE DMBI”, “KAYACURE EPA”, and “KAYACURE OA” manufactured by Nippon Kayaku Co., Ltd.; “Vicure 10” and “Vicure 55” manufactured by Stauffer Chemical Company; “Trigonal P1” manufactured by AKZO N.V.; “Sandoray 1000” manufactured by Sandoz Corporation; “Deap” manufactured by Apjohn Corporation; and “Quantacure PDO”, “Quantacure ITX”, and “Quantacure EPD” manufactured by Ward Blenkinsop Corporation.

The photoinitiator is preferably used in such an amount that it sufficiently functions as a photoinitiator but does not cause precipitation of crystals and impair the physical properties of a coating film; specifically, the amount is preferably in the range of 0.05 to 20 parts by mass, and especially preferably 0.1 to 10 parts by mass relative to 100 parts by mass of the resin composition.

The resin composition of the present invention may further contain a variety of photosensitizers in combination with the photoinitiator. Examples of the photosensitizers include amines, ureas, sulfur-containing compounds, phosphorus-containing compounds, chlorine-containing compounds, and nitriles and other nitrogen-containing compounds.

The active-energy-ray-curable resin composition of the present invention can be produced, for example, by dispersing the fine silica particles (A) in the compound (B) having a (meth)acryloyl group under mixing with a disperser such as DISPER, a dispersing machine equipped with a mixing blade such as a turbine blade, a paint shaker, a roll mill, a ball mill, an attritor, a sand mill, or a bead mill or by dispersing the fine silica particles (A) in the compound (B) having a (meth)acryloyl group and an organic solvent under mixing. Since the fine silica particles (A) are fine wet-process silica particles, any of the above-mentioned dispersers may be used to produce a uniform and stable dispersion. A ball mill or a bead mill is preferably used to produce a more uniform and stable dispersion.

An example of a ball mill suitable for use in the production of the active-energy-ray-curable resin composition of the present invention is a wet ball mill including a vessel charged with media, a rotating shaft, mixing blades having a rotational axis coaxial with the rotating shaft and configured to rotate as the rotating shaft rotates, a raw material inlet disposed on the vessel, a dispersion outlet disposed on the vessel, and a shaft seal disposed at a position where the rotating shaft extends through the vessel. The shaft seal includes two mechanical seal units each including a seal portion sealed with an external seal liquid.

In particular, a method for producing the active-energy-ray-curable resin composition of the present invention, for example, involves use of a wet ball mill including a vessel charged with media, a rotating shaft, mixing blades having a rotational axis coaxial with the rotating shaft and configured to rotate as the rotating shaft rotates, a raw material inlet disposed on the vessel, a dispersion outlet disposed on the vessel, and a shaft seal disposed at a position where the rotating shaft extends through the vessel. The shaft seal includes two mechanical seal units each including a seal portion sealed with an external seal liquid. This method includes supplying resin materials including, as essential components, the fine silica particles (A) and the compound (B) having a (meth)acryloyl group from the inlet to the vessel of the wet ball mill, mixing the materials with the media in the vessel under stirring by rotating the rotating shaft and the mixing blades to crush the fine silica particles (A) and to disperse the fine silica particles (A) in the compound (B) having a (meth)acryloyl group, and discharging the dispersion from the outlet. Such a dispersion method is, for instance, described in detail in Patent Literature 4, and the dispersion process can be carried out by this method also in the present invention.

The active-energy-ray-curable resin composition of the present invention can be used in a coating material. Such a coating material can be applied to a variety of substrates and cured by being exposed to active energy rays to serve as a coating layer for protecting the surfaces of substrates. In this case, the coating material of the present invention may be directly applied to a member of which the surface is to be protected or may be applied to a plastic film and used in the form of a protective film. Alternatively, the coating material of the present invention may be applied to a plastic film to form a coating film and used in the form of an optical film such as an antireflection film, a diffusion film, or a prism sheet. Such a coating film formed by using the coating material of the present invention has a high surface hardness and excellent transparency and can be therefore applied to a variety of plastic films in a thickness suitable for the intended use and used as a protective film or a shaped product that is in the form of a film.

Examples of the plastic film include plastic films and plastic sheets made of polycarbonates, polymethyl methacrylate, polystyrene, polyesters, polyolefins, epoxy resins, melamine resins, triacetylcellulose resins, ABS resins, AS resins, norbornene resins, cyclic olefins, and polyimide resins.

Among the above-mentioned plastic films, polyester films, such as polyethylene terephthalate, generally have a thickness approximately from 30 to 300 μm. These films are inexpensive and easy to be processed and therefore used in a variety of applications such as the displays of touch panels; however, such films are very soft, which makes it difficult to have a sufficiently high surface hardness even when a hard coat layer is formed thereon. In the case where such a polyethylene film is used as a substrate, the coating material of the present invention is preferably applied in such an amount that the thickness of a dried film is in the range of 0.1 to 100 μm, and preferably 0.5 to 80 μm on the basis of the intended use thereof. In general, a coating film of the coating material with a thickness of greater than 30 μm tends to greatly curl as compared with a coating film of the coating material with a relatively small thickness; however, the coating material of the present invention has an excellent resistance to curling, and thus a coating film of the coating material with a relatively large thickness of greater than 30 μm is less likely to suffer from curling and can be suitably used. The coating material may be applied, for example, by bar coating, Meyer bar coating, air knife coating, gravure coating, reverse gravure coating, offset printing, flexography, or screen printing.

Examples of active energy rays used for curing the coating material of the present invention to form a coating film include ultraviolet and electron beams. In the case where the coating material is cured by irradiation with ultraviolet, an ultraviolet-emitting device including a xenon lamp, a high-pressure mercury lamp, or a metal halide lamp as a light source is used. The light intensity and the position of the light source are adjusted if necessary. In the case where a high-pressure mercury lamp is used, the coating film is preferably cured at a transport speed of 5 to 50 m/min relative to a lamp typically having a light intensity of 80 to 160 W/cm. In the case where the coating film is cured with electron beams, it is preferably cured at a transport speed of 5 to 50 m/min with an electron beam accelerator typically having an acceleration voltage of 10 to 300 kV.

The coating material of the present invention is not only applied to a plastic film but also suitably used as a surface coating agent for various shaped plastic products such as mobile phones, home electric appliances, and automotive bumpers. In this case, the coating film may be formed, for example, by coating, a transfer process, or sheet bonding.

The coating is a process that includes applying the coating material to a shaped product by spray coating or with a printing device such as a curtain coater, a roll coater, or a gravure coater to form a topcoat and then curing the topcoat by irradiation with active energy rays.

The transfer process includes applying the coating material of the present invention to a substrate sheet having release properties to form a transfer member, bonding the transfer member to the surface of a shaped product, removing the substrate sheet to transfer the topcoat to the surface of the shaped product, and curing the topcoat by irradiation with active energy rays. An alternative transfer process includes bonding the transfer member to the surface of a shaped product, curing the topcoat by irradiation with active energy rays, and removing the substrate sheet to transfer the topcoat to the surface of the shaped product.

The sheet bonding is a process that includes bonding, to the surface of a shaped plastic product, a protective sheet including a substrate sheet and a coating film formed of the coating material of the present invention thereon or a protective sheet including a substrate sheet having a coating film formed of the coating material thereon and a decorative layer to form a protective layer on the surface of the shaped product.

Among these processes, the coating material of the present invention can be suitably used in a transfer process and sheet bonding.

In the transfer process, a transfer member is first prepared. The transfer member can be produced, for example, by applying the coating material alone or mixed with a polyisocyanate compound to a substrate sheet and then thermally semicuring the coating film (into the B-stage).

In the case where the compound (B) having a (meth)acryloyl group, which is used in the active-energy-ray-curable resin composition of the present invention, is a compound having a hydroxyl group in the molecular structure thereof, such a compound may be used in combination with a polyisocyanate compound in order to efficiently enter the B-stage.

In the production of the transfer member, the coating material of the present invention is applied to a substrate sheet. The coating material may be applied, for example, by a coating process such as gravure coating, roll coating, spray coating, lip coating, or comma coating or by a printing process such as gravure printing or screen printing. The coating material is preferably applied such that the coating film has a thickness of 0.5 to 30 μm, more preferably 1 to 6 μm, after curing. At such a thickness, a coating film has good wear resistance and chemical resistance.

After the coating material is applied to the substrate sheet by the above-mentioned process, the coating film is dried and semicured (into the B-stage) by heating. The heating temperature is typically from 55° C. to 160° C., and preferably from 100° C. to 140° C. The heating period is typically from 30 seconds to 30 minutes, preferably from 1 to 10 minutes, and more preferably from 1 to 5 minutes.

With this transfer member, a surface protective layer is formed on a shaped product, for example, by bonding the B-stage resin layer of the transfer member to the shaped product and then curing the resin layer by irradiation with active energy rays. A specific process, for instance, includes bonding the B-stage resin layer of the transfer member to the surface of the shaped product, removing the substrate sheet from the transfer member to transfer the B-stage resin layer of the transfer member to the surface of the shaped product, and crosslinking and curing the resin layer by irradiation with active energy rays (namely, transfer process). An alternative process includes injecting a resin into the cavity of a mold holding the transfer member to form a shaped resin product while bonding the transfer member to the surface thereof, removing the substrate sheet for transfer to the shaped product, and crosslinking and curing the resin layer by irradiation with active energy rays (namely, simultaneous molding and transfer process).

A specific sheet bonding process includes bonding a substrate sheet of a protective layer sheet prepared in advance to a shaped product and then crosslinking and curing the B-stage resin layer by heating (namely, post-bonding process). An alternative process includes injecting a resin into the cavity of a mold holding the protective layer sheet to form a shaped resin product while bonding the protective layer sheet to the surface thereof and then crosslinking and curing the resin layer by heating (namely, simultaneous molding and transfer process).

The coating film of the present invention is a coating film formed by applying the coating material of the present invention to the above-mentioned plastic film and then curing the applied coating material or a coating film formed by coating a shaped plastic product with the coating material of the present invention that serves as a surface protective agent and then curing the coating material. The film of the present invention is a film having a plastic film and a coating film formed thereon.

Among a variety of applications of the film, a film formed by applying the coating material of the present invention to a plastic film and then curing the coating material by irradiation with active energy rays is preferably used as a protective film for polarizing plates used in liquid crystal displays and displays of touch panels as described above because such a film is excellent in the hardness of the coating film. In particular, in the case where the coating material of the present invention is applied to the protective film of a polarizing plate used in, for instance, liquid crystal displays and displays of touch panels and then cured by being irradiated with active energy rays into a film, the cured coating film of such a protective film has both high hardness and high transparency. Such a protective film for polarizing plates may have an adhesive layer formed on the side opposite to the coating layer formed by application of the coating material of the present invention.

### EXAMPLES

The present invention will now be further specifically described with reference to specific production examples and Examples but are not limited thereto. In the following description, the terms “part” and “%” are on a mass basis unless otherwise specified.

In Examples of the present invention, the weight average molecular weight (Mw) was measured by gel permeation chromatography (GPC) under the following conditions.

Measurement equipment: HLC-8220 manufactured by Tosoh Corporation

Columns: Guard Column H_{XL}-H manufactured by Tosoh Corporation
+TSKgel G5000H_{XL} manufactured by Tosoh Corporation
+TSKgel G4000H_{XL} manufactured by Tosoh Corporation
+TSKgel G3000H_{XL} manufactured by Tosoh Corporation
+TSKgel G2000H_{XL} manufactured by Tosoh Corporation

Detector: RI (differential refractometer)

Data processing: SC-8010 manufactured by Tosoh Corporation

Measurement conditions: Column temperature: 40° C.
Eluent: Tetrahydrofuran
Flow rate: 1.0 ml/min

Standards: Polystyrene

Sample: 0.4 mass % of a tetrahydrofuran solution in terms of the resin solid content was filtered through a microfilter (100 μl)

### Synthesis Example 1: Production of Acrylic Polymer (X-1)

Into a reactor equipped with a stirrer, a cooling pipe, a dropping funnel, and a nitrogen inlet tube, 453 parts by mass of methyl isobutyl ketone was put and then heated under stirring until the internal temperature of the system reached 110° C. Then, a mixture liquid of 720 parts by mass of glycidyl methacrylate, 480 parts by mass of methyl methacrylate, and 48 parts by mass of t-butyl peroxy-2-ethylhexanoate (“PERBUTYL O” manufactured by NIPPON NYUKAZAI CO., LTD.) was dropped thereto over 3 hours with the dropping funnel, and the content was held at 110° C. for 15 hours. The temperature was decreased to 90° C., 1.6 parts by mass of METHOQUINONE and 367 parts by mass of an acrylic acid were subsequently added thereto, and 7.8 parts by mass of triphenylphosphine was further added. The temperature was subsequently increased to 100° C., and the resulting product was held for 8 hours, thereby yielding 3000 parts by mass of a solution of an acrylic polymer (X-1) in methyl isobutyl ketone (nonvolatile content: 50.0 mass %). The acrylic polymer (X-1) had the following properties: weight average molecular weight (Mw) of 13,000, theoretical acryloyl equivalent of 321 g/eq on a solid basis, and hydroxyl value of 108 mgKOH/g.

### Synthesis Example 2: Production of Urethane Acrylate (B-1)

Into a reactor equipped with a stirrer, 166 parts by mass of dicyclohexylmethane-4,4′-diisocyanate, 0.2 parts by mass of dibutyltin dilaurate, and 0.2 parts by mass of METHOQUINONE were put; and the content was heated to 60° under stirring. Then, 630 parts by mass of pentaerythritol triacrylate (“ARONIX M-305” manufactured by TOAGOSEI CO., LTD.) was added thereto in 10 portions every 10 minutes. The mixture was further subjected to a reaction for 10 hours. The reaction was terminated when it was determined by infrared spectroscopy that absorption by isocyanate groups at 22,500 cm⁻¹ had disappeared, thereby obtaining a urethane acrylate (B-1). The urethane acrylate (B-1) had the following properties: weight average molecular weight (Mw) of 1,400 and theoretical acryloyl equivalent of 120 g/eq.

### Example 1

Slurry having a nonvolatile content of 50 mass % was prepared from 40 parts by mass of the solution of the acrylic polymer (X-1) in methyl isobutyl ketone, which had been produced in Synthesis Example 1, (20.0 parts by mass of the acrylic polymer (X-1)), 30 parts by mass of a polyfunctional acrylate monomer (“ARONIX M-404” manufactured by TOAGOSEI CO., LTD.), 50 parts by mass of fine wet-process silica particles (A-1) subjected to a hydrophobic treatment (SS-50F, wet-process silica particles, treated with polydimethylsiloxane, manufactured by TOSOH SILICA CORPORATION), and 80 parts by mass of methyl isobutyl ketone (hereinafter abbreviated as “MIBK”) and then mixed and dispersed with a wet ball mill (“Starmill LMZ015” manufactured by Ashizawa Finetech Ltd.) to obtain a dispersion.

The dispersion with the wet ball mill was performed under the following conditions.

Medium: zirconia beads with median size of 100 μm

Filling rate of mill with resin composition by internal volume of mill: 70 volume %

Peripheral speed of tips of mixing blades: 11 m/sec

Flow rate of resin composition: 200 ml/min

Dispersion period: 60 minutes

The average particle size in the obtained dispersion was measured with a particle size analyzer (“ELSZ-2” manufactured by Otsuka Electronics Co., Ltd.).

To the resulting dispersion, 2 parts by mass of a photoinitiator (“IRGACURE #184” manufactured by Ciba Specialty Chemicals) was added. Then, MIBK and PGM were added thereto to adjust the nonvolatile content to be 40 mass %, thereby obtaining an active-energy-ray-curable resin composition. The active-energy-ray-curable resin composition was subjected to the following tests in order to evaluate its properties. Table 1 shows results of the tests.

Pencil Hardness Test of Coating Film

1. Preparation of Test Sample

The active-energy-ray-curable resin composition was applied to the following plastic films with a bar coater such that the coating films each had the intended thickness after being cured. The applied resin composition was dried at 70° C. for a minute and transported at a radiation dose of 250 mJ/cm² with a high-pressure mercury lamp under nitrogen atmosphere to be cured, thereby yielding test samples each having a cured coating film.

0.5 μm, on a polyethylene terephthalate film (hereinafter abbreviated as “PET”, thickness: 125 μm)
0.5 μm, on a triacetylcellulose film (hereinafter abbreviated as “TAC”, thickness: 60 μm)

2. Pencil Hardness Test

The cured coating films of the test samples were evaluated by a pencil hardness test in accordance with JIS K 5400; the load was 750 g for the test sample with the substrate of a polyethylene terephthalate film and 500 g for the substrate of a triacetylcellulose film. The test was performed five times, and the hardness that was at a next lower level than the hardness at which one or more scars were caused was determined as the pencil hardness of the coating film.

Test for Transparency of Coating Film

1. Preparation of Cured Coating Film

The active-energy-ray-curable resin composition was applied to the following plastic film with a bar coater such that the coating film had the intended thickness after being cured. The applied resin composition was dried at 70° C. for a minute and transported at a radiation dose of 250 mJ/cm² with a high-pressure mercury lamp under nitrogen atmosphere to be cured, thereby yielding a test sample having a cured coating film.

0.3 μm, on a polyethylene terephthalate film (hereinafter abbreviated as “PET”, thickness: 75 μm)

2. Transparency Test

The haze of the coating film was measured with a “Haze Computer HZ-2” manufactured by Suga Test Instruments Co., Ltd. The lower the haze, the higher the transparency of the coating film.

Test for Resistance of Coating Film to Curling

1. Preparation of Cured Coating Film

The active-energy-ray-curable resin composition was applied to the following plastic film with a bar coater such that the coating film had the intended thickness after being cured. The applied resin composition was dried at 70° C. for a minute and transported at a radiation dose of 250 mJ/cm² with a high-pressure mercury lamp under nitrogen atmosphere to be cured, thereby yielding a test sample having a cured coating film.

0.5 μm, on a polyethylene terephthalate film (hereinafter abbreviated as “PET”, thickness: 75 μm)

2. Test for Resistance to Curling

The test sample was cut into a square of 10 cm, and the degree of turning-up from the level was measured at each corner thereof, and the average of the measurement results was used for evaluation. The smaller the average, the less the curling, which means that the coating film had excellent resistance to curling.

Test for Anti-Blocking Properties of Coating Film

1. Preparation of Cured Coating Film

The active-energy-ray-curable resin composition was applied to the following plastic film with a bar coater such that the coating film had the intended thickness after being cured. The applied resin composition was dried at 70° C. for a minute and transported at a radiation dose of 250 mJ/cm² with a high-pressure mercury lamp under nitrogen atmosphere to be cured, thereby yielding a test sample having a cured coating film.

0.3 μm, on a polyethylene terephthalate film (hereinafter abbreviated as “PET”, thickness: 75 μm)

2. Test for Anti-Blocking Properties

A film coated with an all-purpose ultraviolet-curable resin (for example, UNIDIC 17-806 manufactured by DIC Corporation) was brought into contact with the coated surface of the test sample, and these films were rubbed with each other under application of a load. A test result was evaluated as ◯ (anti-blocking properties were found) in the case where the films smoothly slid and as x (blocked) in the case where the films did not slide.

### Examples 2 to 5

Active-energy-ray-curable resin compositions were produced as in Example 1 except that the constitution thereof was changed as shown in Table 1. These resin compositions were subjected to the same tests as in Example 1. Table 1 shows results of the tests.

The following component was used in a composition.

Fine silica particles (A-2): polydimethylsiloxane-treated fine wet-process silica particles “SAZ-20B”, manufactured by TOSOH SILICA CORPORATION

TABLE 1

| | Exam- | Exam- | Exam- | Exam- | Exam- |
|---|---|---|---|---|---|
| | ple 1 | ple 2 | ple 3 | ple 4 | ple 5 |
| Fine silica particles (A-1) | 50 | | 45 | 60 | 50 |
| Fine silica particles (A-2) | | 50 | | | |
| Acrylic polymer (X-1) | 20 | 20 | | | |
| Urethane acrylate (B-1) | | | 30 | 20 | |
| ARONIX M-404 | 30 | 30 | 25 | 20 | 50 |
| HAZE | 0.5 | 0.5 | 0.3 | 0.75 | 0.3 |
| Appearance of coating | Smooth | Smooth | Smooth | Smooth | Smooth |
| Curling mm | 0.2 | 0.2 | 1.1 | 0.8 | 2 |
| Pencil Hardness | 3H | 3H | 3H | 3H | 4H |
| Pencil Hardness | 4H | 4H | 4H | 4H | 4H |
| Anti-blocking properties | ◯ | ◯ | Δ | ◯ | ◯ |
| Particle size | 116 | 120 | 114 | 119 | 120 |

### Comparative Example 1

Slurry having a nonvolatile content of 50 mass % was prepared from 40 parts by mass of the solution of the acrylic polymer (X-1) in MIBK, which had been produced in Synthesis Example 1, (20.0 parts by mass of the acrylic polymer (X-1)), 30 parts by mass of ARONIX M-404, 50 parts by mass of fine silica particles (A′-1) (hydrophobic fumed silica AEROSIL R7200, manufactured by Evonik Industries AG), and 80 parts by mass of MIBK and mixed and dispersed with a wet ball mill (“Starmill LMZ015” manufactured by Ashizawa Finetech Ltd.) to obtain a dispersion. The dispersion was used to prepare an active-energy-ray-curable resin composition as in Example 1, and the same tests as in Example 1 were carried out. Table 2 shows results of the tests.

The dispersion with the wet ball mill was performed under the following conditions.

Medium: zirconia beads with median size of 100 μm

Filling rate of mill with resin composition by internal volume of mill: 70 volume %

Peripheral speed of tips of mixing blades: 11 m/sec

Flow rate of resin composition: 200 ml/min

Dispersion period: 40 minutes

The average particle size in the obtained dispersion was measured with a particle size analyzer (“ELSZ-2” manufactured by Otsuka Electronics Co., Ltd.).

### Comparative Examples 2 and 3

Active-energy-ray-curable resin compositions were produced as in Comparative Example 1 except that the constitution thereof was changed as shown in Table 2. These resin compositions were subjected to the same tests as in Example 1. Table 2 shows results of the tests.

Fine silica particles (A′-2) (hydrophobic fumed silica AEROSIL R8200, manufactured by Evonik Industries AG)

### Comparative Example 4

Slurry having a nonvolatile content of 50 mass % was prepared from 40 parts by mass of the solution of the acrylic polymer (X-1) in MIBK, which had been produced in Synthesis Example 1, (20.0 parts by mass of the acrylic polymer (X-1)), 30 parts by mass of ARONIX M-404, 50 parts by mass of fine silica particles (A′-3) (E-220A, untreated precipitated silica particles, manufactured by TOSOH SILICA CORPORATION), 5 parts by mass of organopolysiloxane, and 80 parts by mass of MIBK and mixed and dispersed with a wet ball mill (“Starmill LMZ015” manufactured by Ashizawa Finetech Ltd.) to obtain a dispersion. The dispersion was used to prepare an active-energy-ray-curable resin composition as in Comparative Example 1, and the same tests as in Example 1 were carried out. Table 2 shows results of the tests.

The dispersion with the wet ball mill was performed under the following conditions.

Medium: zirconia beads with median size of 100 μm

Filling rate of mill with resin composition by internal volume of mill: 70 volume %

Peripheral speed of tips of mixing blades: 11 m/sec

Flow rate of resin composition: 200 ml/min

Dispersion period: 90 minutes

The average particle size in the obtained dispersion was measured with a particle size analyzer (“ELSZ-2” manufactured by Otsuka Electronics Co., Ltd.).

TABLE 2

| | Comparative | Comparative | Comparative | Comparative |
|---|---|---|---|---|
| | Example 1 | Example 2 | Example 3 | Example 4 |
| Fine silica particles (A′-1) | 50 | 55 | | |
| Fine silica particles (A′-2) | | | 50 | |
| Fine silica particles (A′-3) | | | | 50 |
| Acrylic polymer (X-1) | 40 | 30 | 20 | 40 |
| ARONIX M-404 | 30 | 30 | 40 | 30 |
| Organopolysiloxane | | | | 5 |
| Transparency | 0.6 | 0.8 | 0.7 | 2.5 |
| Appearance of coating | Partially | Partially | Partially | Rough surface |
| | rough | rough | rough | |
| | surface | surface | surface | |
| Resistance to curling [mm] | 3.5 | 4.5 | 4.0 | — |
| Pencil Hardness [5μ on PET] | 3H | 3H | 2H | — |
| Pencil Hardness [5μ on TAC] | 4H | 4H | 2H | — |
| Anti-blocking properties | ◯ | ◯ | ◯ | — |
| Average particle size [nm] | 115 | 120 | 118 | Overdispersion |

1-12. (canceled)

13. An active-energy-ray-curable resin composition comprising fine wet-process silica particles (A) subjected to a hydrophobic treatment and a compound (B) having a (meth)acryloyl group, wherein the fine wet-process silica particles (A) are dispersed so as to have an average particle size ranging from 90 to 130 nm.

14. The active-energy-ray-curable resin composition according to claim 13, wherein the hydrophobic treatment is treating the surfaces of fine silica particles obtained by a wet process with polydimethylsiloxane.

15. The active-energy-ray-curable resin composition according to claim 13, wherein the amount of the fine wet-process silica particles (A) subjected to a hydrophobic treatment is in the range of 5 to 80 parts by mass in 100 parts by mass of the nonvolatile content of the active-energy-ray-curable resin composition.

16. The active-energy-ray-curable resin composition according to claim 13, wherein the compound (B) having a (meth)acryloyl group is an acrylic polymer (X) which has a (meth)acryloyl group in the molecular structure and of which the weight average molecular weight (Mw) is in the range of 3,000 to 80,000.

17. The active-energy-ray-curable resin composition according to claim 16, wherein the (meth)acryloyl equivalent of the acrylic polymer (X) is in the range of 220 to 1650 eq/g.

18. The active-energy-ray-curable resin composition according to claim 16, wherein the acrylic polymer (X) has a hydroxyl group in the molecular structure, and the hydroxyl equivalent is in the range of 35 to 250 mgKOH/g.

19. The active-energy-ray-curable resin composition according to claim 13, wherein the compound (B) having a (meth)acryloyl group is a di- or higher functional (meth)acrylate monomer.

20. A cured product comprising the active-energy-ray-curable resin composition according to claim 13.

21. A laminate film comprising a plastic film and a coating film formed of the active-energy-ray-curable resin composition according to claim 13 on at least one surface of the plastic film.
